(19) United States
(12) Patent Application Publication
(10) Pub. No.: US 2011/0247842 A1
(43) Pub. Date: Oct. 13, 2011

(54) Wildfire protection system

(76) Inventor: Hayden Huber, Virginia Beach, VA (US)

(21) Appl. No.: 12/798,885

(22) Filed: Apr. 12, 2010

(51) Int. Cl. A62C 31/24; A62C 3/00

(52) U.S. Cl. 169/54; 169/16; 239/208

(57) ABSTRACT

A wildfire protection system has at least one rotating sprinkler having a base mounted atop a ridge of a structure or dwelling roof. The rotating sprinkler is coupled to one end of a typical garden hose having an opposite end coupled to a hose bib for providing water thereto. The base of the rotating sprinkler includes a metallic or fire proof material and includes mounting holes for fastening the sprinkler to the roof. When deployed, the sprinkler wets the rooftop and nearby flammable materials to prevent the structure or dwelling from being set on fire by flying embers and the like.

There are no related patent applications.

The present invention did not receive federal research and/or development funding.

### TECHNICAL FIELD

Generally, the present invention relates to the field of fire protection systems which includes oscillating sprinklers. More particularly, the invention relates at least one sprinkler arranged atop a structure that is to be protected from wildfire and configured into a system that couples to a water source provided thorough a hose bib and a standard garden hose.

### BACKGROUND OF THE INVENTION

The costs associated with wildfires annually exceeds one billion dollars in the United States. Many dwellings or structures are set afire by flaming embers discharged from within the wildfire. These embers tend to fall onto roof tops and set the roofing materials such as shingles ablaze. It is a primary aim of this invention to assist property owners in protecting their structures or dwellings from wildfires by extinguishing any falling embers and dampening an exterior of the structures and dwellings that are protected by the instant invention.

There are a variety afire suppression systems that comprise sprinklers. One such system was patented by Timothy Orrange, U.S. Pat. No. 6,360,968, which is incorporated herein by reference thereto. Orrange includes a sprinkler system which includes a plurality of legs and weighted elements for mounting a sprinkler atop a roof. Other examples of the most-closely related known but yet different devices and systems are described in the following patent documents. U.S. Pat. No. 5,263,543, issued to Nigro on Nov. 23, 1993, taught a sprinkler system mounted on a roof permanently as a roof fixture. U.S. Pat. No. 4,824,020, issued to Harward, described a sprinkler stand on legs, but the legs are attached pivotally to a hub or table to be pivoted between parallel positions for being carried and angular positions for use with points of the legs being positioned in soil to arrest pivoting. U.S. Pat. No. 4,330,040, issued to Ence, et al., described a fire preventing and cooling system with tubes having orifices permanently on rooftops for dispensing water. U.S. Pat. No. 4,091,876, issued to Valdatta, described a fire sprinkler system for mobile homes having a loop of tubing mounted on the perimeter of their flat roofs with sprinklers pointed inwardly. U.S. Pat. No. 3,576,212, issued to Siler, taught a fire-shielding device with sprinklers on stands positioned on ground surfaces and extended higher than a roof of a building for spraying water on the roof effectively.

### SUMMARY OF THE INVENTION

The present invention is a rooftop sprinkler system that comprises at least one rotating sprinkler having a threaded water inlet for accepting a threaded end from a garden hose. The sprinkler includes a dual-sided base formed of fire resistant material and having a particular angle of substantially ninety degrees. It should be noted that the base is preferably formed from a flexible, resilient material that may be substantially formed to a particular angle of a peak of a roof that is smaller or larger than the angle of the peak of the roof. The sprinkler is fastened to the base at the particular angle of the roof peak. Openings are preferably arranged along a bottom edge of each side for fastening the base onto the rooftop to prevent the sprinkler from being blown off of the rooftop during windy conditions that are present around wildfires.

Multiple sprinklers may be coupled together and used for covering a larger area. In this instance, each sprinkler comprises a t-shaped connector that includes an input which mates with a threaded end of a garden hose. The t-shaped connector is arranged beneath the sprinkler head and having a first output that feeds water to the sprinkler head. A second output includes a removable, threaded, waterproof cap that mates and seals water from discharging from the second output. This removable, threaded cap is removed and replaced with an end of a water hose when the sprinkler is configured in a system. The cap may be left in place if there are no other sprinklers downstream from the particular sprinkler within the system. Two garden hoses are respectively coupled to the input and second output of the t-connector. One garden hose operates as an input and delivers the water to the sprinkler(s) from the hose bib or a second output of a sprinkler arranged upstream from the sprinkler. The other garden hose is coupled to the threaded output and provides an input of water to the input of a t-connector arranged downstream from the sprinkler, if the sprinkler is configured in a system.

It is an object of the invention to teach an inexpensive system for protecting buildings and structures from wildfires that is simple to manufacture and intuitive to use and which may be easily removed and stored when no in use. Otherwise, the sprinkler system may be installed and left in place for an indefinite period of time.

It is another object of the invention to teach a fire protection system that may be installed by a home owner and remotely operated when the threat of wildfire is present.

It is a further object of the invention to teach a rotating sprinkler having an angled base fixed to a ridge of a rooftop.

Further objects, features and advantages of the invention will become apparent from a consideration of the following description and the included claims when taken in connection with the previous discussion and the accompanying drawings. The above explanations are provided to illustrate the utility of the invention. And, by no means necessary are these explanations intended to limit the application of this invention from being used for other purposes.

### DESCRIPTION OF THE DRAWINGS

FIG. 1 is a perspective view of the invention shown from the side.

FIG. 2 is an exploded view of the invention.

FIG. 3 is a perspective view of a wildfire protective system comprising the invention.

### DETAILED DESCRIPTION OF THE INVENTION

The following is the preferred embodiment or best mode for carrying out the invention. It should be noted that this invention is not limited by the discussion of the various embodiments and should only be defined by the appended claims. Moreover, it should be recognized that this invention is not limited by the discussion of the preferred embodiments, but that skilled artisans may easily recognize that certain modifications may be made without deviating from the spirit of the invention.

The sprinkler for use in the present invention includes an oscillating or rotating sprinkler head that sprays an arcuate pattern about the sprinkler. The sprinkler may be adjustable to spray only a portion of 360 degrees for covering corners, dormers, and the like and may even spray in a full 360 degree pattern. The sprinkler head comprises a revolving nozzle sitting atop a sprinkler housing having a water input. The water input is sized to accept and mate with an end of a garden hose. The spray generated by the revolving nozzle covers at least a rooftop and surrounding materials, flora, and the like with a fine, even spray of water. The sprinkler may be formed from a variety of materials including composite materials, polymer materials, light-weight metals such as aluminum, zinc, and brass. The sprinkler head is designed with an adjustable diffusion plate or deflector which allows the angle of the water to be altered and to control the spray distance. The spray radius is also adjusted by tightening or loosening a diffusion pin to adjust the amount of water between a heavy and a light spray. Otherwise adjustable collars may be used for rotation control. The sprinkler head can either be allowed to rotate in a full circle or a portion of a circle.

The base is preferably formed from fire resistant material such as formed composite or lightweight aluminum. Molding techniques and metal stamping and shaping means and methods may be utilized in creating the base of the rotating sprinkler. For instance, if the base is made of a composite or polymer material, the base may be formed through a molding process. If the base comprises a metal, then metal working techniques such as shaping through use of a hydraulic press and wedge may be used. The mounting holes may be formed along an edge of each side by either drilling or stamping them out. The material is flexible and resilient to allow the base to conform to different pitched roofs.

In the preferred embodiment, the base is formed from a single piece of material having two sides angled relative to one another. When installed onto a peaked rooftop, each side sits on a specific side of the ridge of the roof. At least one plurality of openings is arranged along the edge of each side. Fasteners such as nail and screws are driven through each opening to secure the sprinkler to rooftop.

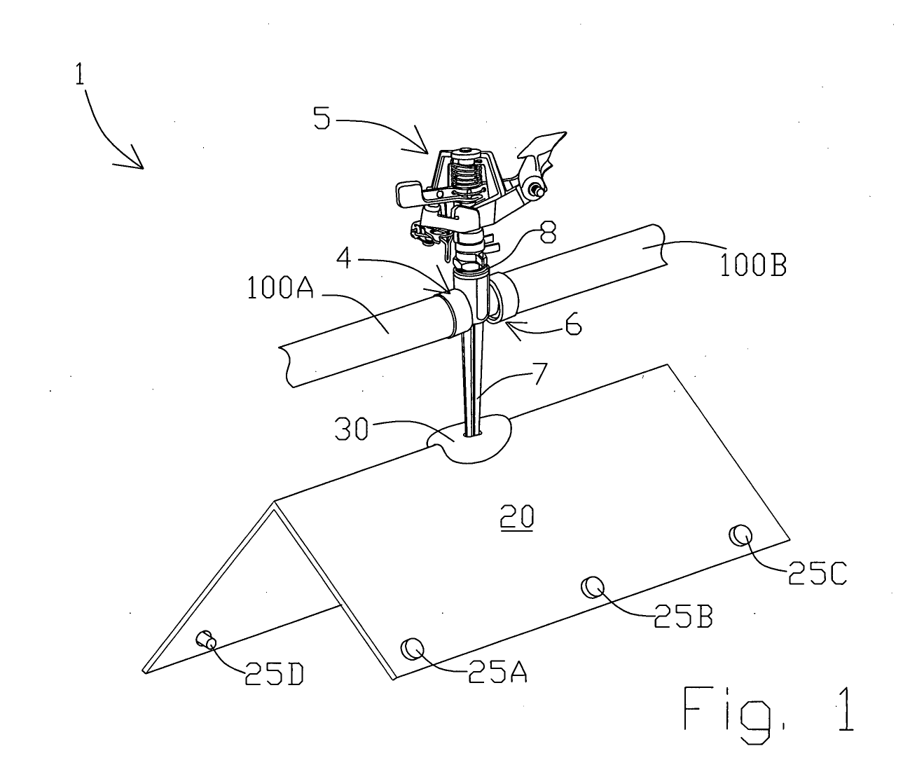

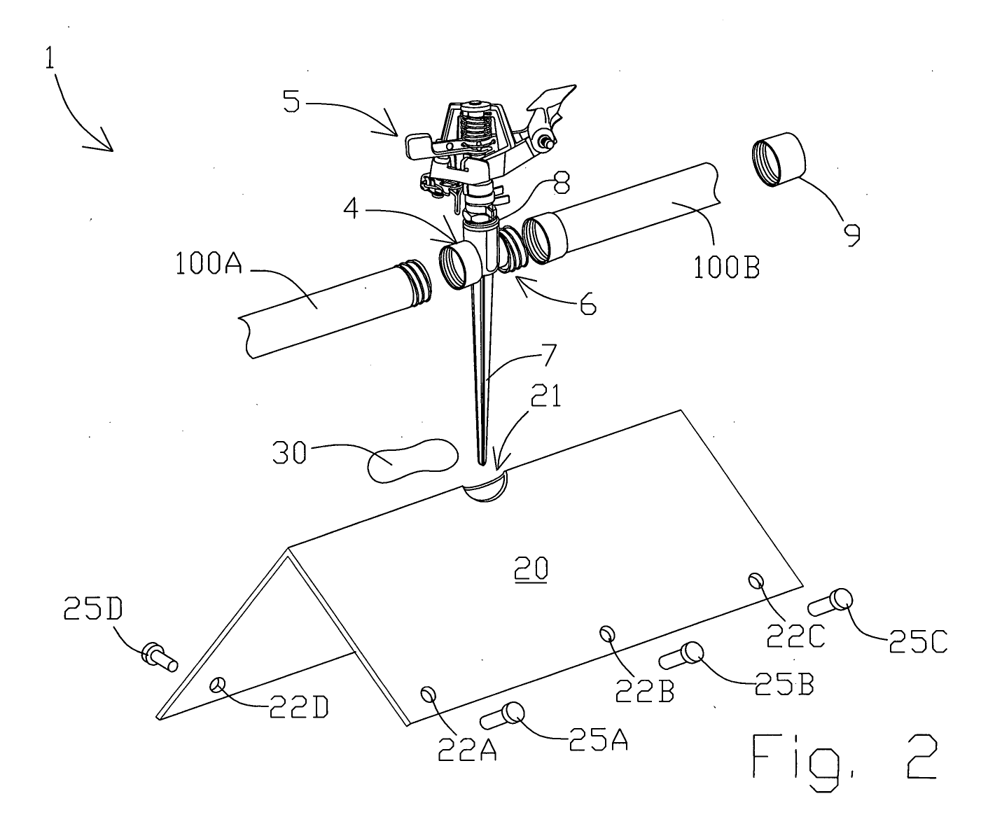

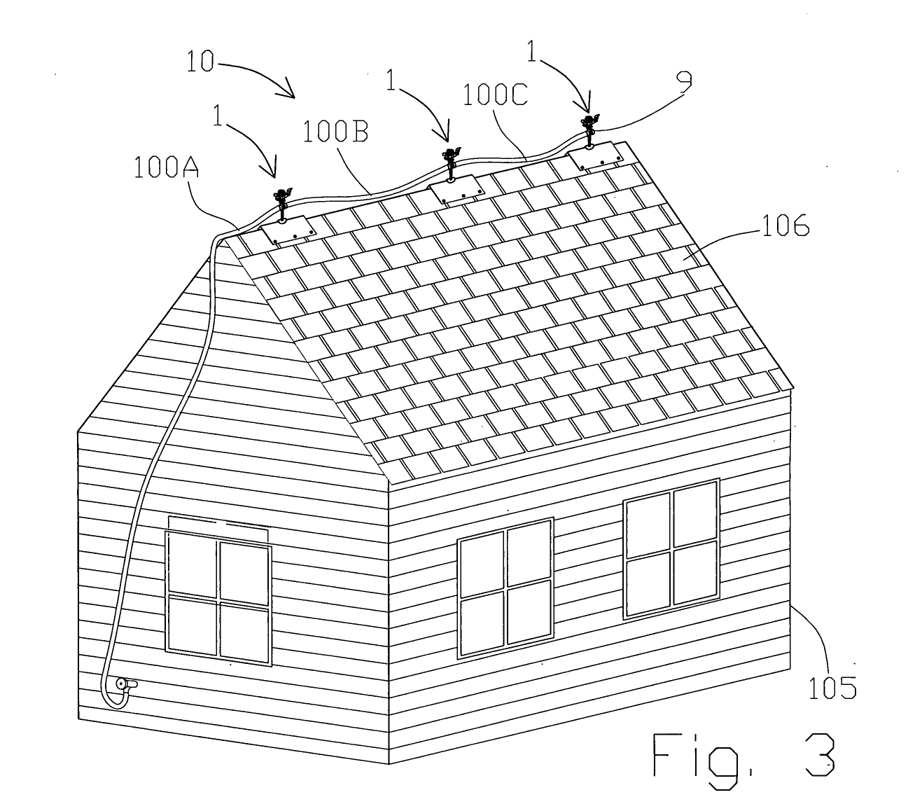

Turning now to FIGS. 1-2, the sprinkler 1 includes a sprinkler head 5 affixed atop a t-connector that includes input 4, output 6 and output 8. Input 4 comprises a female threaded connector having garden hose thread that accommodate a male threaded end of a garden hose having outer diameter of 1.0625 inches and 11.5 threads per inch. Output 6 is a male threaded connector having garden hose thread with an outer diameter of 1.0625″ and 11.5 threads per inch. Output 8 is preferably smaller in diameter than either output 6 or input 4. This smaller diameter creates a pressure increase in the water as it passes from the input water hose 100A. It also ensures equal distribution of the water among all sprinklers when configured in a system as shown in FIG. 3. As can be understood, the input 4 includes threads that accept a standard garden hose which includes a typical diameter of ½″ or ⅝″ and may be readily purchased from a local hardware supply store.

The sprinkler head 5 couples to the first output 8 of the t-connector via a spring clamp as shown. The bottom of the t-connector may be formed with a vertical upright 7 that acts to elevate the t-connector and sprinkler head 5 above the angled base 20 and roof peak, as noted in FIG. 3. This vertical upright 7 also elevates supply water hose 100A and feed water hose 100B above the base 20. Base 20 includes an opening center between the ends and sided of thereof for receiving an end of the vertical upright 7 opposite the t-connector. Adhesive 30 may be an epoxy such as JB Weld® and secures the bottom end of the vertical upright to the base 20. Base 20 includes an opening centered between the dual sides of the base and from end to end for receiving the end of the vertical upright opposite the t-connector.

As can be recognized in the figures, each side of the base 20 includes a plurality of openings 22A-22D and associated fasteners 25A-25D. The fasteners 25A-D pass through their respective opening 22A-D and fasten the base 20 to the peak of the roof 106 of building 105, as shown in FIG. 3. A threaded end cap 9 is included on each t-connector over the output 6 and may be removed for fastening feed water hoses 100B, 100C as shown in FIG. 3. In this manner, a plurality of sprinklers 1 may be arranged in a system 10.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A wildfire protection system to be mounted atop a roof of a structure comprising:
a rotating sprinkler head;
a t-connector having an input comprising a female threaded connector having garden hose threads that accommodate a male threaded end of a garden hose to receive water there from, said t-connector further comprising a first output in fluid contact with the rotating sprinkler head to provide water thereto, a second output comprising a male threaded connector having garden hose thread;
a removable fluid tight end cap having female garden hose threads and being affixed to the threaded opening of the second output to create a water tight seal;
a vertical upright connected at an upper end to the t-connector opposite the first output;
an angled base that sits atop a ridge of a roof, said angled base affixed to an end of the vertical upright opposite the t-connector and comprising two sides each having an edge that includes a plurality of openings;
a plurality of fasteners, each passing through a respective opening in the plurality of openings arranged along the edges of the angled base and being fastened into the roof;
a garden hose connected at one end to a hose bib which supplies water and connected at an opposite end to the input of the t-connector.

2. The wildfire protection system of claim 1 wherein said second output comprising a male threaded connector having garden hose thread, with an outer diameter of 1.0625″ and 11.5 threads per inch.

3. The wildfire protection system of claim 1 wherein the input comprises a female threaded connector having an inner diameter of 1.0625 inches and 11.5 threads per inch.

4. The wildfire protection system of claim 1 wherein said base comprises an opening that is centered between the two sides and ends of the base and into which an end of the vertical upright is fastened via an adhesive.

5. The wildfire protection system of claim 4 wherein said adhesive is an epoxy.

6. The wildfire protection system of claim 1 wherein the rotating sprinkler head comprises of one or more materials selected from a group consisting of a composite, a polymer, aluminum, zinc, and brass.

7. The wildfire protection system of claim 1 wherein the rotating sprinkler head comprises an adjustable diffusion plate which allows an angle at which the water is ejected from the rotating sprinkler head to be altered and to control a spraying distance of water from the rotating sprinkler head.

8. The wildfire protection system of claim 1 wherein a size of a radius of water spraying from the rotating sprinkler head is adjusted by tightening or loosening a diffusion pin to adjust the amount of water between a heavy and a light spray.

9. The wildfire protection system of claim 1 wherein said rotating sprinkler head comprises at least one adjustable collar used for rotation control.

10. The wildfire protection system of claim 1 wherein said rotating sprinkler head rotates in a full circle or a portion of a circle.

11. The wildfire protection system of claim 1 further comprising a second rotating sprinkler head connected to a second t-connector having an input comprising a female threaded connector having garden hose threads that accommodate a male threaded end of a garden hose to receive water there from, said t-connector further comprising a first output in fluid contact with the rotating sprinkler head to provide water thereto, a second output comprising a male threaded connector having garden hose thread, a removable fluid tight end cap having female garden hose threads and being affixed to the threaded opening of the second output to create a water tight seal, a vertical upright connected at an upper end to the t-connector opposite the first output, an angled base that sits atop a ridge of a roof, said angled base affixed to an end of the vertical upright opposite the t-connector and comprising two sides each having an edge that includes a plurality of openings, a plurality of fasteners, each passing through a respective opening in the plurality of openings arranged along the edges of the angled base and being fastened into the roof, a garden hose connected at one end to a hose bib which supplies water and connected at an opposite end to the input of the t-connector; and
a garden hose connected between the second output of one sprinkler and the input of the other sprinkler.

12. A wildfire protection system to be mounted atop a roof of a structure comprising:
a rotating sprinkler head;
a t-connector having an input having garden hose threads and comprising a female threaded connector having an inner diameter of 1.0625 inches and 11.5 threads per inch that accommodate a male threaded end of a garden hose to receive water there from, said t-connector further comprising a first output in fluid contact with the rotating sprinkler head to provide water thereto, a second output comprising a male threaded connector having garden hose thread with an outer diameter of 1.0625″ and 11.5 threads per inch;
a removable fluid tight end cap having female garden hose threads and being affixed to the threaded opening of the second output to create a water tight seal;
a vertical upright connected at an upper end to the t-connector opposite the first output;
an angled base that sits atop a ridge of a roof, said angled base affixed to an end of the vertical upright opposite the t-connector and comprising two sides each having an edge that includes a plurality of openings;
a plurality of fasteners, each passing through a respective opening in the plurality of openings arranged along the edges of the angled base and being fastened into the roof;
a garden hose connected at one end to a hose bib which supplies water and connected at an opposite end to the input of the t-connector.

13. The wildfire protection system of claim 12 further comprising a second rotating sprinkler head connected to a second t-connector having an input comprising a female threaded connector having garden hose threads that accommodate a male threaded end of a garden hose to receive water there from, said t-connector further comprising a first output in fluid contact with the rotating sprinkler head to provide water thereto, a second output comprising a male threaded connector having garden hose thread, a removable fluid tight end cap having female garden hose threads and being affixed to the threaded opening of the second output to create a water tight seal, a vertical upright connected at an upper end to the t-connector opposite the first output, an angled base that sits atop a ridge of a roof, said angled base affixed to an end of the vertical upright opposite the t-connector and comprising two sides each having an edge that includes a plurality of openings, a plurality of fasteners, each passing through a respective opening in the plurality of openings arranged along the edges of the angled base and being fastened into the roof, a garden hose connected at one end to a hose bib which supplies water and connected at an opposite end to the input of the t-connector; and
a garden hose connected between the second output of one sprinkler and the input of the other sprinkler.

14. The wildfire protection system of claim 12 wherein said base comprises an opening that is centered between the two sides and ends of the base and into which an end of the vertical upright is fastened via an adhesive.

15. The wildfire protection system of claim 14 wherein said adhesive is an epoxy.

16. The wildfire protection system of claim 12 wherein the rotating sprinkler head comprises of one or more materials selected from a group consisting of a composite, a polymer, aluminum, zinc, and brass.

17. The wildfire protection system of claim 12 wherein the rotating sprinkler head comprises an adjustable diffusion plate which allows an angle at which the water is ejected from the rotating sprinkler head to be altered and to control a spraying distance of water from the rotating sprinkler head.

18. The wildfire protection system of claim 12 wherein a size of a radius of water spraying from the rotating sprinkler head is adjusted by tightening or loosening a diffusion pin to adjust the amount of water between a heavy and a light spray.

19. The wildfire protection system of claim 12 wherein said rotating sprinkler head comprises at least one adjustable collar used for rotation control.

20. The wildfire protection system of claim 12 wherein said rotating sprinkler head rotates in a full circle or a portion of a circle.
